(19) United States
(12) Patent Application Publication
(10) Pub. No.: US 2017/0101209 A1
(43) Pub. Date: Apr. 13, 2017

(54) Growler

(71) Applicant: Cash J Viedt, South Burlington, VT (US)

(72) Inventor: Cash J Viedt, South Burlington, VT (US)

(21) Appl. No.: 14/878,116

(22) Filed: Oct. 8, 2015

(51) Int. Cl. B65D 1/02; B67D 3/00; B65D 47/12; B65D 25/42; B65D 41/02

(52) U.S. Cl. CPC B65D 1/0246; B65D 25/42; B65D 41/02; B65D 47/127; B67D 3/0061

(57) ABSTRACT

An improved growler has a lower container portion and upper container portion which can be unscrewed from each other. Once separated, the lower container portion and upper container portion are more easily and effectively cleaned, especially when compared to existing growlers. The improved growler benefits further from the addition at least one fluid transfer port. One fluid transfer port, placed on a lateral surface of the lower container portion, is a self-sealing valve (e.g. stem valve) that allows for the improved growler to be more easily filled from a keg tap or similar device. A second fluid transfer port can be positioned into a neck of the upper container portion, which allows for air to flow into the improved growler in order to facilitate smoother pouring of liquids. A fluid transfer port is also capable of converting the improved growler into a smoking apparatus by coupling with a stem bowl.

### FIELD OF THE INVENTION

The present invention relates generally to a container which separates for easier cleaning. Improvements are also made to facilitate filling of the container, provide for smoother pouring, and allow for converted use as a smoking apparatus.

### BACKGROUND OF THE INVENTION

Growlers, a type of beer bottle, are often used to store larger amounts of alcohol. The increased amount of storage may be attractive to groups of people (as compared to buying smaller individual bottles) or to persons who like to keep local or craft brews in stock at their personal residences. With a larger size (most commonly 32 ounces or 64 ounces) than single serve bottles, growlers are commonly washed and reused rather than being discarded. Unfortunately, growlers often have narrow opening and larger interior volumes, the combination of which makes sanitization difficult.

The present invention seeks to address this difficulty by implanting a separable lower container portion and upper container portion. By allowing a person to separate the two portions, improved access to the interior of the growler is provided. This makes it easier for a user to apply soap to the growler, as well as completely rinse away the soap when finished. Drying the interior of the growler is also made easier, which helps prevent the spread of bacteria that would otherwise thrive in moist environments.

In some embodiments of the present invention, fluid transfer ports are added to improve effectiveness as a growler and allow for alternative use of the present invention as a smoking device.

Ultimately, the present invention serves as an improved growler which provides several advantages.

### BRIEF DESCRIPTION OF THE DRAWINGS

FIG. 1 is a perspective view of the present invention.

FIG. 2 is a front view of the present invention.

FIG. 3 is a right-side view of the present invention.

FIG. 4 is an exploded perspective view of the present invention.

FIG. 5 is an exploded bottom perspective view of the present invention.

FIG. 6 is a perspective view showing a lower container portion of the present invention.

FIG. 7 is a front view of an alternative embodiment of the lower container portion, showing a fluid transfer port.

FIG. 8 is a perspective view of the alternative embodiment lower container portion showing a fluid transfer port.

FIG. 9 is a front view showing an upper container portion of the present invention.

FIG. 10 is a perspective view showing the upper container portion of the present invention.

FIG. 11 is a front view of an alternative embodiment of the upper container portion, showing a fluid transfer port.

FIG. 12 is a perspective view of the alternative embodiment upper container portion showing a fluid transfer port.

### DETAIL DESCRIPTIONS OF THE INVENTION

All illustrations of the drawings are for the purpose of describing selected versions of the present invention and are not intended to limit the scope of the present invention.

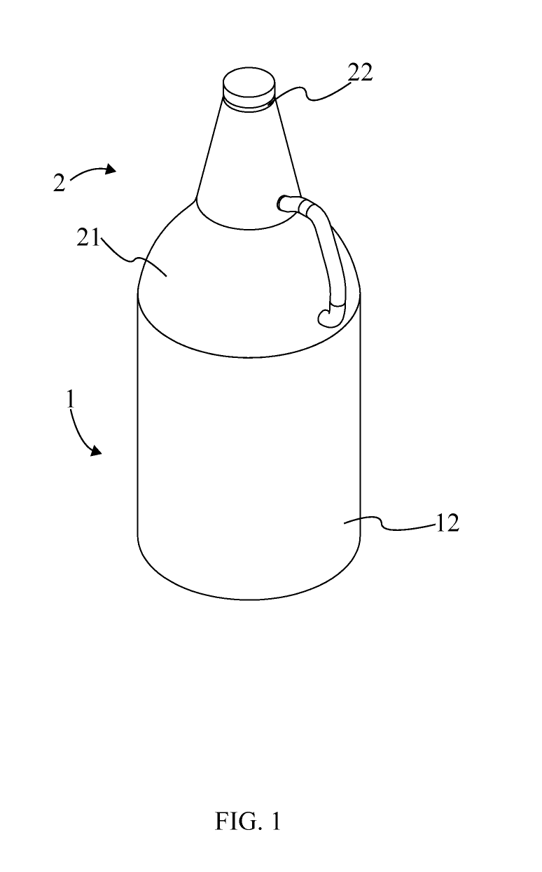

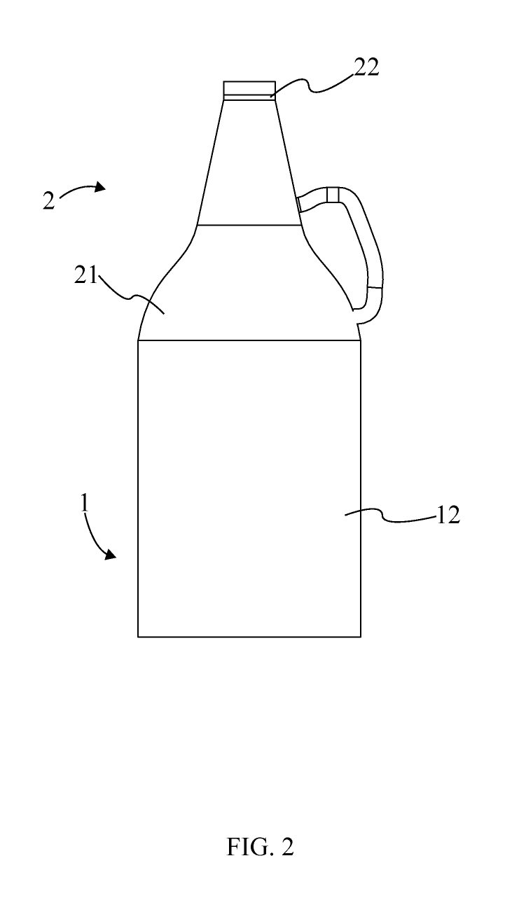

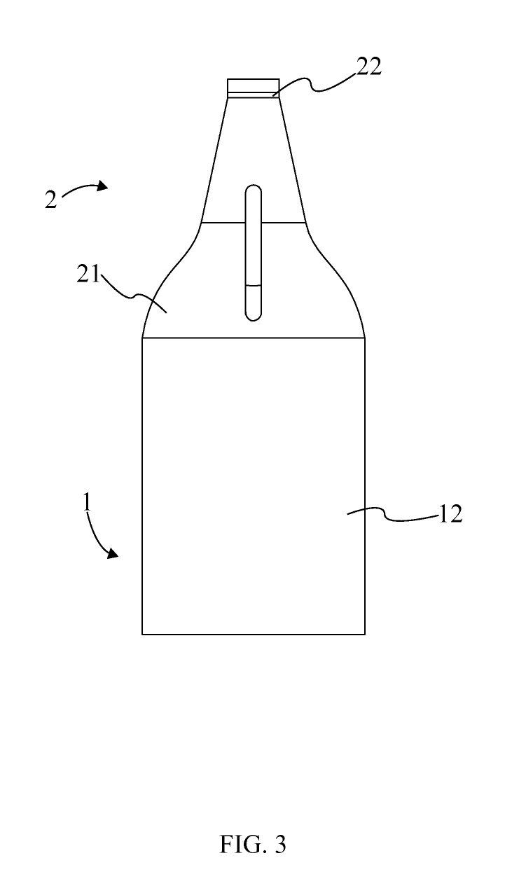

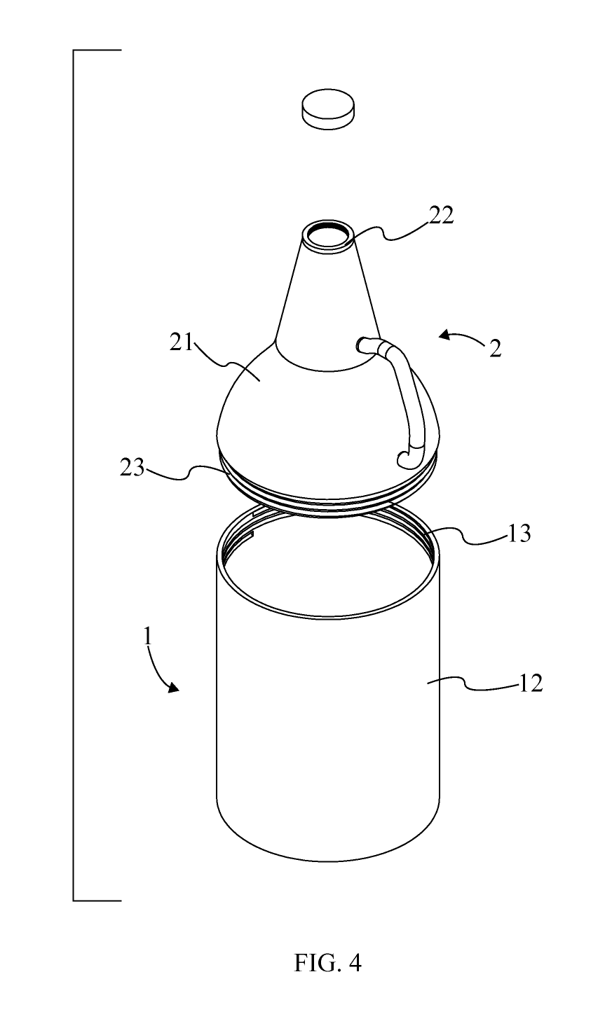

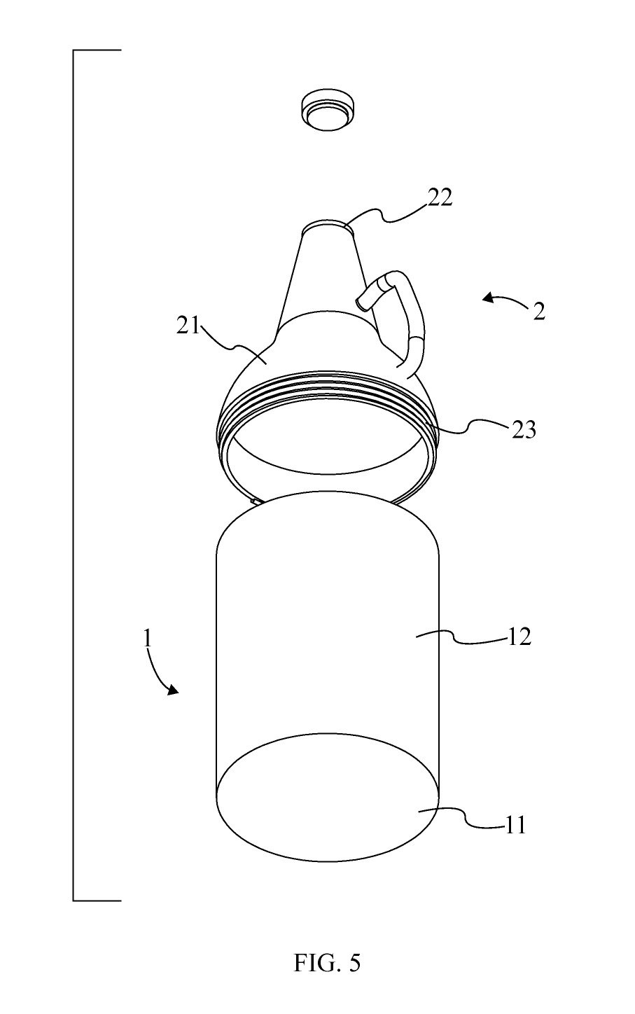

The present invention is an improved growler with a separable top and bottom. The separable top and bottom allows for a more thorough cleaning of the growler, especially in comparison to existing unibody growlers. In support of this, the present invention comprises a lower container portion 1 and an upper container portion 2 which are removably attached to each other. The lower container portion 1 itself comprises a base 11 and a lateral surface 12. The upper container portion 2 comprises a neck 21 and a mouth 22. The lateral surface 12 and base 11 form the bottom and lower wall of the improved growler, with the lateral surface 12 being perimetrically connected to the base 11. The neck 21 and mouth 22, meanwhile, form the top section of the improved growler. The neck 21 itself is perimetrically attached to the lateral surface 12, with the mouth 22 being positioned opposite the lateral surface 12 along the neck 21. This relation between the neck 21 and the lateral surface 12 allows the improved growler to be disassembled into two pieces in the interest of sanitization. As the improved growler is intended to contain fluids, the lower container portion 1 and upper container portion 2 are hermetically sealed with each other, ensuring that liquids do not leak out of the seam between said lower container portion 1 and upper container portion 2. The present invention is shown via FIG. 1-FIG. 12.

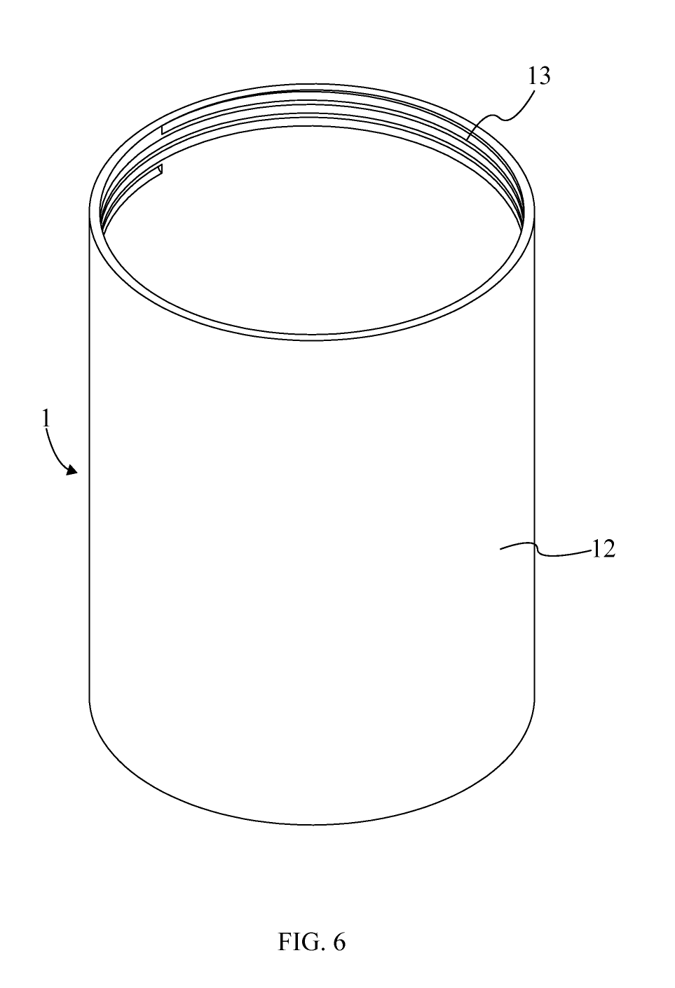

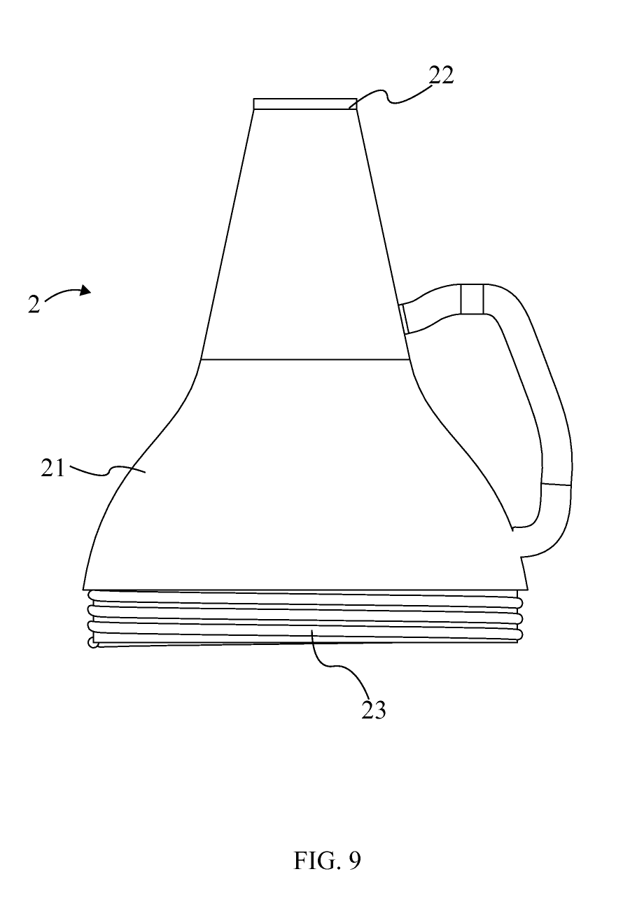

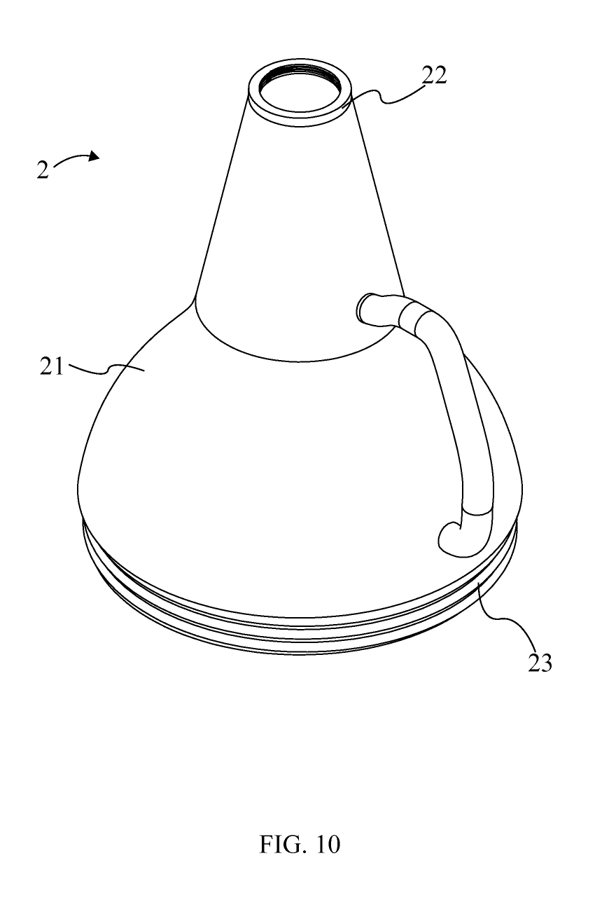

In the illustrated embodiment, the lower container portion 1 and the upper container portion 2 are attached to each other through the use of a matching threading. More specifically, the lateral surface 12 comprises a first threading 13 while the neck 21 comprises a second threading 23. The first threading 13 spirals around the lateral surface 12 at the open edge; that is, the first threading 13 is positioned opposite the base 11 along the lateral surface 12. The second threading 23 similarly spirals around the neck 21, at an open edge of the neck 21. The second threading 23 is thus positioned opposite the mouth 22 along the neck 21. The lower container portion 1 and upper container portion 2 can thus be screwed together through a helical engagement between the first threading 13 and the second threading 23. The lower container portion 1 and upper container portion 2 are shown together in FIG. 1-FIG. 5. The lower container portion 1 is shown by itself in FIG. 6 while the upper container portion 2 is shown individually in FIG. 9 and FIG. 10.

In other embodiments, different means of attaching the lower container portion 1 and upper container portion 2 can be utilized. For example, in one embodiment a clamp is positioned around the seam formed between the lower container portion 1 and the upper container portion 2. This clamp can be engaged and disengaged in order to seal and release, respectively, the lower container portion 1 and the upper container portion 2.

In another embodiment, a first flange of the lower container portion 1 is secured to a second flange of the upper container portion 2 in order to attach the two bodies together. The two flanges can be secured with fasteners such as thumb screws, allowing a user to attach and detach the two bodies without the need for tools.

The above are just a few examples of possible ways the lower container portion 1 and upper container portion 2 can be attached to each other. Preferably, the attachment means utilized is simple and easy to use, such as the threaded engagement of the illustrated embodiment. The attachment means must also be capable of hermetically sealing the lower container portion 1 and upper container portion 2, as leaks greatly degrade the functionality of the present invention.

The present invention, as heretofore described, can be separated into separate pieces that allow for the improved growler to be more easily cleaned. Additional embodiments, for example which further improve the functionality of the improved growler or allow for multipurpose use of the improved growler, are subsequently described.

In one embodiment, at least one fluid transfer port 3 is provided for the improved growler. The at least one fluid transfer port 3, in this embodiment, serves as a connection for keg taps, allowing for the growler to more easily be filled. The fluid transfer port 3 traverses into the lateral surface 12 of the lower container portion 1, creating an inlet that allows for fluids to flow from an external source (e.g. the aforementioned keg tap) into the improved growler.

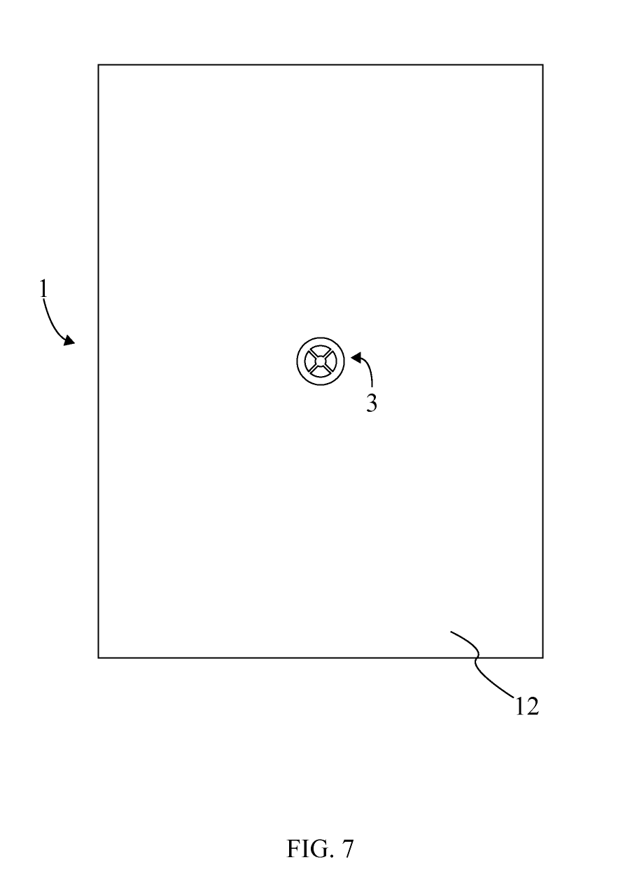

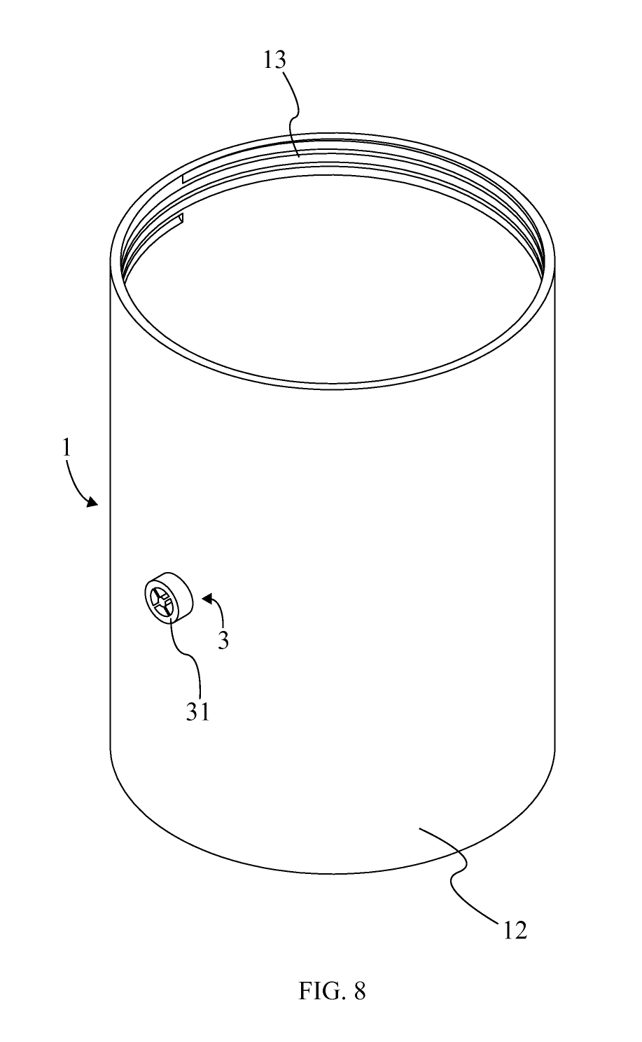

The fluid transfer port 3 itself comprise an adapter end 31, which allows for interfacing of an external object with the fluid transfer port 3. The adapter end 31 is thus positioned opposite the lateral surface 12 along the fluid transfer port 3. This adapter end 31 is additionally in fluid communication with the lower container portion 1 through the fluid transfer port 3, allowing for fluids to enter the adapter end 31, pass through the fluid transfer port 3, and enter the interior volume of the improved growler. This embodiment is shown in FIG. 7 and FIG. 8.

In a variation of this embodiment, the fluid transfer port 3 traverses through the neck 21, rather than through the lateral surface 12. This variant is otherwise the same as the embodiment in which the fluid transfer port 3 traverses through the lateral surface 12. The main difference is that the adapter end 31 of the fluid transfer port 3 is positioned opposite the neck 21 along the fluid transfer port 3. Fluids can thus enter the adapter end 31, travel through the fluid transfer port 3, and enter the interior volume of the improved growler at the neck 21 area.

The main fluid transfer port 3 itself, preferably, is a valve stem. A valve stem is advantageous as it automatically seals itself when not in use. As a result, the valve stem maintains a sealed environment within the improved growler (when not in use) while still allowing for the input of fluids (e.g. beer) into the improved growler as desired.

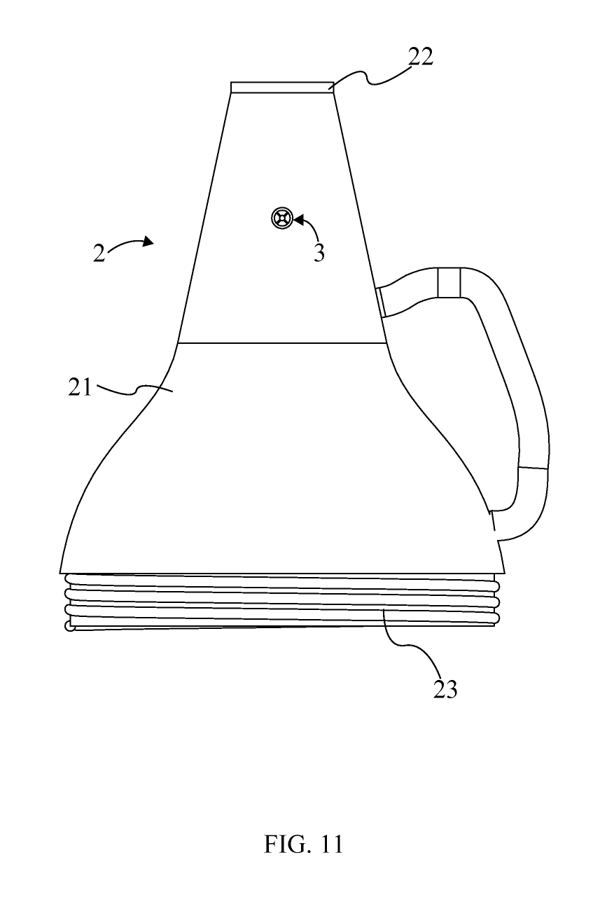

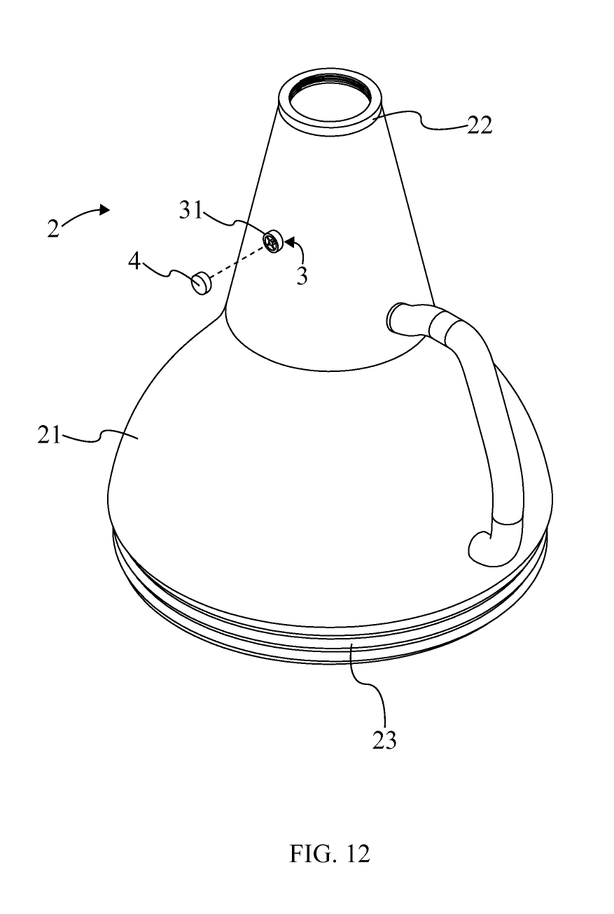

The second fluid transfer port 3, primarily intended to allow for movement of gases rather than liquids, is manually sealed. This is in comparison to the aforementioned main fluid transfer port 3, which is preferably self-sealing. The sealing of the second fluid transfer port 3 can be as simple a cap 4, which is removable attached to the second fluid transfer. The cap 4 can thus allow or prevent movement of gases into and out of the corresponding fluid transfer port 3. Alternatively, the manual sealing mechanism could be a lever-actuated valve, such as a butterfly valve or ball valve. Ultimately, any device which is capable of selectively sealing the second fluid transfer port 3 can be utilized as part of the present invention. Illustrations of the embodiment, showing cap 4, are provided via FIG. 11 and FIG. 12.

The present invention is not limited to utilizing valve stems as the fluid transfer port 3; in other embodiments different types of fluid transfer ports 3 can be utilized. For example, the fluid transfer port 3 could be any type of valve or inlet device that allows for fluids to enter the interior volume of the improved growler. For implementations that are not self-sealing, a sealing mechanism for the fluid transfer port 3 will also need to be provided. By selectively engaging and disengaging such a sealing mechanism, a user is able to allow or prevent the passage of fluids through the fluid transfer port 3.

The present invention is not limited to being utilized with a single fluid transfer port 3. For example, in one possible embodiment, the present invention comprises two fluid transfer ports 3. One fluid transfer port 3, as previously described, allows for the improved growler to more easily be filled with a keg tap or similar tool. The additional fluid transfer port 3 can assist with pouring liquids from the improved growler by enabling improved airflow (a feature often integrated into gas cans, for example). This fluid transfer port 3 can be opened when pouring liquids out of the mouth 22 of the improved growler; the fluid transfer port 3 is otherwise closed to keep the interior volume of the improved growler sealed, helping to better store contents of the improved growler.

This secondary fluid transfer port 3 could, potentially, also be utilized to convert the improved growler into a smoking apparatus. For example, if the improved growler is emptied of liquids (e.g. beer), a bowl stem filled with smokeable substances can be joined to the secondary fluid transfer port 3. This allows for generated smoke to enter the interior of the improved growler through the fluid transfer port 3, from which it can be inhaled from an opening of the mouth 22. In this manner, the present invention is suitable for use as beverage container and smoking apparatus.

As the secondary fluid transfer port 3 is often used to smooth out pouring contents of the improved growler, the second fluid transfer port 3 is preferably located on the neck 21 of the growler; if this secondary fluid transfer port 3 were instead located on the lateral surface 12, liquids could leak out of the fluid transfer port 3 when being poured.

The size of the at least one fluid transfer port 3 is not restricted by the present invention. Rather, the size of each individual fluid transfer port 3 is adapted to suit the intended purpose. For example, the fluid transfer port 3 provide to allow for quicker filling of the improved growler is preferably sized to interface with standardized keg taps. A smaller fluid transfer port 3 is able to serve as an inlet for bowl stems, enable smoother fluid flow when pouring a drink from the improved growler, or both.

The benefits of the present invention are thus two-fold. The primary benefit of the present invention is the ability to separate the improved growler into the lower container portion 1 and the upper container portion 2, allowing a user to more easily and thoroughly clean the interior surface of said improved growler. The addition of at least one fluid transfer port 3 further improves the qualities of the improved growler by allowing for easier refilling (e.g. by coupling a keg tap one of the at least one fluid transfer ports 3). Pouring capability is also improved as a result of a secondary smaller fluid transfer port 3, which allows for air to enter the improved growler in order to normalize interior pressure and provide a smoother flow of liquid.

The integration of the secondary, smaller fluid transfer port 3 also allows for the improved growler to be converted for use as a smoking apparatus. By coupling a bowl stem or similar item with the secondary fluid transfer port 3, smoke can be input into the container through the fluid transfer port 3 and inhaled from an opening of the mouth 22. The present invention is thus suitable for multi-purpose use, e.g. smoking and drinking. For example, the improved growler can be provided for a party, which begins with consumption of alcohol stored within the improved growler and continues with smoking. The present invention is thus capable of appealing to persons who engage in common social and recreational activities, e.g. drinking and smoking.

While the present invention has been described with a preferred embodiment and several possible embodiments, further variants of the present invention are still possible. For example, the dividing cut between the lower container portion 1 and upper container portion 2 could be moved closer to the base 11 or closer to the mouth 22. While the position shown in the preferred and illustrated embodiment is preferable, it does not preclude these alternative positions. Ultimately, while a number of different placements for the dividing cut are possible, it is desirable to have the largest possible cross section at the juncture between the lower container portion 1 and the upper container portion 2 (as illustrated) to increase ease of access for cleaning.

Further components beyond those described are also possible. For example, as shown in the illustrated embodiments, a handle and bottle top can be provided for the improved growler. Other components which are commonly utilized with growlers can also be integrated with the improved growler without departing from the scope of the present invention.

Although the invention has been explained in relation to its preferred embodiment, it is to be understood that many other possible modifications and variations can be made without departing from the spirit and scope of the invention as hereinafter claimed.

What is claimed is:

1. An improved growler comprises:
a lower container portion
an upper container portion
the lower container portion comprises a base and a lateral surface;
the upper container portion comprises a neck and a spout;
the lateral surface being perimetrically connected to the base;
the neck being perimetrically attached to the lateral surface;
the spout being positioned opposite the lateral surface along the neck; and
the lower container portion being hermetically sealed with the lower container portion.

2. The improved growler as claimed in claim 1 comprises:
an at least one fluid transfer port;
the at least one fluid transfer port traversing into the lower container portion through the lateral surface.

3. The improved growler as claimed in claim 2 comprises:
the at least one fluid transfer port comprises an adapter end;
the adapter end being positioned opposite the lateral surface along the at least one fluid transfer port; and
the adapter end being in fluid communication with the lower container portion through the at least one fluid transfer port.

4. The improved growler as claimed in claim 2 comprises:
the at least one fluid transfer port being a valve stem.

5. The improved growler as claimed in claim 1 comprises:
an at least one fluid transfer port; and
the at least one fluid transfer port traversing into the upper container portion through the neck.

6. The improved growler as claimed in claim 5 comprises:
the at least one fluid transfer port comprises an adapter end;
the adapter end being positioned opposite the lateral surface along the at least one fluid transfer port; and
the adapter end being in fluid communication with the lower container portion through the at least one fluid transfer port.

7. The improved growler as claimed in claim 5 comprises:
the at least one fluid transfer port being a valve stem.

8. The improved growler as claimed in claim 5 comprises:
a cap; and
the cap being adjacently attached to the at least one fluid transfer port.

9. The improved growler as claimed in claim 1 comprises:
the lateral surface comprises a first threading;
the neck comprises a second threading;
the first threading being positioned opposite the base along the lateral surface;
the second threading being positioned opposite the spout along the neck; and
the first threading being helically engaged with the second threading.

10. An improved growler comprises:
a lower container portion;
an upper container portion;
an at least one fluid transfer port;
the lower container portion comprises a base and a lateral surface;
the upper container portion comprises a neck and a spout;
the lateral surface being perimetrically connected to the base;
the neck being perimetrically attached to the lateral surface;
the spout being positioned opposite the lateral surface along the neck;
the lower container portion being hermetically sealed with the lower container portion; and
the at least one fluid transfer port traversing into the lower container portion through the lateral surface.

11. The improved growler as claimed in claim 10 comprises:
the at least one fluid transfer port comprises an adapter end;
the adapter end being positioned opposite the lateral surface along the at least one fluid transfer port; and
the adapter end being in fluid communication with the lower container portion through the at least one fluid transfer port.

12. The improved growler as claimed in claim 10 comprises:
the at least one fluid transfer port being a valve stem.

13. The improved growler as claimed in claim 10 comprises:
a cap; and
the cap being adjacently attached to the at least one fluid transfer port.

14. The improved growler as claimed in claim 10 comprises:
the lateral surface comprises a first threading;
the neck comprises a second threading;
the first threading being positioned opposite the base along the lateral surface;
the second threading being positioned opposite the spout along the neck; and
the first threading being helically engaged with the second threading.

15. An improved growler comprises:
a lower container portion;
an upper container portion;
an at least one fluid transfer port;
the lower container portion comprises a base and a lateral surface;
the upper container portion comprises a neck and a spout;
the lateral surface being perimetrically connected to the base;
the neck being perimetrically attached to the lateral surface;
the spout being positioned opposite the lateral surface along the neck;
the lower container portion being hermetically sealed with the lower container portion; and
the at least one fluid transfer port traversing into the upper container portion through the neck.

16. The improved growler as claimed in claim 15 comprises:
the at least one fluid transfer port comprises an adapter end;
the adapter end being positioned opposite the lateral surface along the at least one fluid transfer port; and
the adapter end being in fluid communication with the lower container portion through the at least one fluid transfer port.

17. The improved growler as claimed in claim 15 comprises:
the at least one fluid transfer port being a valve stem.

18. The improved growler as claimed in claim 15 comprises:
a cap; and
the cap being adjacently attached to the at least one fluid transfer port.

19. The improved growler as claimed in claim 15 comprises:
the lateral surface comprises a first threading;
the neck comprises a second threading;
the first threading being positioned opposite the base along the lateral surface;
the second threading being positioned opposite the spout along the neck; and
the first threading being helically engaged with the second threading.
